(19) United States
(12) Patent Application Publication
(10) Pub. No.: US 2002/0072923 A1
(43) Pub. Date: Jun. 13, 2002

(54) Waste management method and system

(76) Inventor: Robert W. Guidry, Petersburg, VA (US)

Correspondence Address: Saul Ewing LLP, Centre Square West, 1500 Market Street-38th Floor, Philadelphia, PA, 19102-2186, US

(21) Appl. No.: 09/909,554

(22) Filed: Jul. 20, 2001

Related U.S. Application Data
(60) Provisional application No. 60/219,533, filed on Jul. 20, 2000.

(51) Int. Cl. G06F 17/60

(52) U.S. Cl. 705/1; 705/13

(57) ABSTRACT

The present invention verifies, records and monitors pertinent data involving haulers, their drivers, vehicles and trailers, hired to transport materials between various site locations. The present invention ensures hauler and driver compliance with contract and state regulatory requirements by controlling site access, denying site access to those without valid credentials and refusing delivery from those with improper loads. The system includes a site controller located at each remote site, the site controller authorizing site access and recording site transaction data. A central controller communicates with the site controllers, receiving site transaction data from the site controllers (for management report generation) and transmitting operating information and site access authorization data to the site controllers (for site access authorizations). An identification device, retaining pertinent information regarding the hauler, the driver and the trailer is evaluated by the respective site controller, which authorizes site access upon credential verification.

### RELATED APPLICATIONS

The present application claims priority from pending provisional application 60/219,533, filed Jul. 20, 2000, entitled “Waste Management System”.

### FIELD OF THE INVENTION

The present invention relates generally to a method and system for managing and monitoring transportation activity, and more particularly to a method and system for verifying credentials of and recording transactions involving haulers, their drivers and trailers, hired to transport waste between various remote sites, to ensure compliance with state regulatory and individual contract requirements.

### BACKGROUND OF THE INVENTION

Currently no method or system is available to a transportation management entity, responsible for material deliveries to and from remote sites, to verify credentials of haulers (transport organizations) hired to transport the materials, in real time, and record hauler transactions to and from the remote sites. Without a system to verify, at the time of pickup and delivery, the credentials of drivers, haulers and trailers, and record the date/time and material weight of pickup and deliveries, the transportation management entity cannot prevent, before the fact, the use of unqualified drivers, the delivery of overweight or incorrect loads, delivery to incorrect destinations and deliveries using improper routes.

The transportation management entity is often liable for costs resulting from improper deliveries, hauler accidents and vehicle violations, even if the hauler is an independent, third-party subcontractor. In addition, the transportation management entity suffers from poor public relations and loss of goodwill when negligent haulers are involved in accidents and/or incur fines due to regulatory violations.

The above-noted costs are especially excessive when the material transported is waste. Hauler accidents often involve environmental clean-up costs and legal costs and vehicle violations are high due to the sensitive and specifically regulated nature of waste transportation and disposal. Furthermore, pending legislation in various states intends to prevent or severely restrict the transportation and/or disposal of waste over certain state lines.

For the foregoing reasons, there is a need for a method and system to verify the credentials of and monitor transactions involving haulers, at the time of material pickup and delivery, for management and control of hauler activity to ensure compliance with contract and state regulatory requirements, and minimize liability associated with hauler accidents and violations.

### SUMMARY OF THE INVENTION

The present invention is a method and system to verify, record and monitor pertinent data involving haulers, their drivers, vehicles and trailers, hired to transport materials between various site locations. The present invention ensures hauler and driver compliance with hauler contract and state regulatory requirements by controlling site access, the present invention denying site access to those without valid credentials and refusing delivery from those with improper loads.

In one aspect of the present invention, a transportation management system is provided which includes a site controller located at each remote site. The site controller is used to authorize site access. The system further includes a central controller located at a central management location which communicates with each site controller. The central controller transmits operating information and site access authorization data to each site controller. Site access is provided to transporting entities through use of an identification device that interacts with the site controllers at each remote site. The identification device retains identification information about the transporting entity which is verified by the respective site controller using the operating information and site access authorization data communicated to each site controller. Upon verification of pre-determined credentials, a respective site controller authorizes site access.

In another aspect of the present invention, the transportation management system also records transaction data involving the transporting entities at each remote site. Site transaction data is recorded to a respective site controller, which periodically transmits the site transaction data to the central controller. The site controllers could also write the transaction data to the identification device of the transporting entity. The central controller generates statistics based on the transaction data for use by managing personnel.

In a further aspect of the present invention, a method for controlling access to sites (for control of a pick-up and delivery trip) of a transportation network is provided. Access is controlled by verifying pre-determined characteristics of a transporting entity at a first remote site, where a positive verification provides the transporting entity access to the first remote site. Transactions occurring at the first remote site are then recorded. At a second remote site pre-determined characteristics of the transporting entity are again verified along with pre-determined data from the transaction occurring at the first remote site. A positive verification provides the transporting entity access to the second remote site for delivery of materials loaded at the first remote site.

In a still further aspect of the present invention, the above method is further used to manage and monitor a transportation network by adding the steps of recording pre-determined second remote site transaction data and then evaluating the first remote site transaction data with the second remote site transaction data to create statistics, and generate reports, used to manage and monitor the transportation network.

In yet another aspect of the present invention, the methods and systems above are directed to transporting waste, where the first remote site is a transfer station and the second remote site is a landfill. The transportation network could include hundreds, or thousands, of remote sites (transfer stations and landfills) separated by hundreds, or thousands, of miles. The transporting entity could be a third-party, subcontract hauler represented by a driver having a vehicle with trailer. The transporting entity could also be a direct employee or some other independent person or entity. The identification device could be an identification card with read/write memory chip.

It is therefore one object of the present invention to track and verify the credentials of contracted third-party waste haulers, their driver's, vehicles and trailers, thereby controlling hauler access to transfer stations and landfills.

It is another object of the present invention to that ensure that trailer weights are in compliance with regulatory requirements and that the trailer weight leaving a transfer station equals that arriving at a landfill (at least within an allowable differential).

It is a further object of the present invention to ensure that trailers of material leaving a transfer station arrive at their assigned landfill and that no trailer is accepted at a landfill unless previously assigned to that landfill.

It is a still further object of the present invention to electronically record information regarding, and transactions involving, organizations (haulers), their drivers, vehicles and trailers, hired to transport waste from transfer stations to landfills, to generate data assisting in the management of a waste transporting network.

### BRIEF DESCRIPTION OF THE DRAWINGS

For the purpose of illustrating the invention, there is shown in the drawings a form which is presently preferred; it being understood, however, that this invention is not limited to the precise arrangements and instrumentalities shown.

FIG. 1 illustrates by flow diagram a transfer station (TS) inbound verification and transaction process undertaken by a driver, representing a hauler, hired to transport waste from a transfer station to an assigned landfill, in accordance with the present invention;

FIG. 2 illustrates by flow diagram a transfer station (TS) outbound verification and transaction process undertaken by a driver, representing a hauler, hired to transport material from the transfer station to an assigned landfill, in accordance with the present invention; and

FIG. 3 illustrates by flow diagram a landfill (LF) inbound verification and transaction process undertaken by a driver, representing a hauler, hired to transport material from a transfer station to the landfill, in accordance with the present invention.

### DETAILED DESCRIPTION OF THE INVENTION

The present invention is a method and system for use by a transportation management entity to enforce contract and regulatory compliance by transporting entities hired to transport goods between remote site locations. The present invention also records and monitors (through report generation) transporting entity transactions occurring at the remote site locations to track delivery timeliness and adequacy. Generally, a transporting entity is defined as any one (or all) of a hauling organization, a driver, vehicle or trailer.

While the method and system of the present invention is applicable to any transportation management entity coordinating a point to point network of material pick-up and deliveries, the detailed description of the invention is directed to a waste management organization operating a network of transfer stations “TS” (first remote site locations) and landfills “LF” (second remote site locations). Waste is the material transported and the transporting entities are independent, third-party haulers contracted to transport waste from certain transfer stations to certain landfills. It is understood that the haulers and/or drivers could be employees of the transportation management entity, or representatives of some other, independent contracting organization.

### System Components

Waste Management Unit (WMU)—Site Controller

The waste management unit (WMU) is a scale house mounted microprocessor based trip accounting and site access controller (site controller) that accumulates transaction data and controls site access. The WMU could be a personal computer, or a microprocessor based device interfacing with a computer existing at the remote site location (such as a computerized weigh scale system).

In one embodiment of a WMU interfacing with weigh scale hardware and software, the WMU includes a control panel having a liquid crystal display (LCD) that is 2 lines by 40 characters, a numeric keypad (0 through 9, A through D, Enter/Yes, and Clear/No), and a identification card (IDcard) receptacle. It is through the control panel that the IDcard gains access to the WMU.

Identification Card (IDcard)

The IDcard is the WMU's unique access device provided to initiate a transaction at the WMU. All IDcards are constructed alike with a read/write memory chip housed in a durable plastic card. Ancillary equipment and software could be included to print pictures (photo identifications) and organizational logos on the IDcards.

IDcards are encoded as a driver card or a site manager card. A driver card is assigned to each driver (hauler representative) for verification (site access authorization) and transaction recording purposes during remote site visits. A site manager card is assigned to remote site managers to override certain verification and transaction requirements, change system functions and assist with WMU diagnostics.

Generally, a driver card has two categories of information:

1. Encoded data (via Central Controller at a central management location)—Driver ID, Name, Employer Organization (hauler), date of commercial driver's license (CDL) expiration, date of motor vehicle report (MVR) expiration date, physical (medical exam) expiration, etc. See driver database, below. Generally, the expiration date of the IDcard is the date of the first credential (CDL, MVR, physical) to expire.

2. Updateable data (via WMU by site representative or site manager)—Trailer ID, Gross Vehicle Weight, destination ID, etc. See transfer station outbound transaction data, below.

Scale House

The scale house is a typical location, within the first remote site location (transfer station) and the second remote site location (landfill), where the operator interface for the weigh scales is located. At this location, the scale operator has access to the WMU, and to the computer system directly interfacing the weigh scales and WMU (if this is the chosen design).

A computerized scale operation is not required to implement the method and system of the present invention. Since many remote site locations have computerized scale operations for record-keeping purposes, the method and system of the present invention is designed to electronically communicate with the databases included in the scale system software.

Scales & Scale Software

The WMU has a serial interface port and internal firmware written to communicate with software operating the weigh scales at each remote site.

Central Controller

The central controller can be an IBM-compatible personal computer (PC) with a hard drive, monitor, keyboard, modem (internal or external), and parallel printer. The central controller is located at a central accounting or a central management location. The central controller communicates with the WMU(s) at sites via a modem. The central controller receives transaction data from the WMU(s) and is used to input (upload) operating information and access authorization data to each WMU.

One central management location could exist for an entire (nationwide) transportation network, or central management locations could be regionalized. In one embodiment of the present invention, one regional central management location covers 11 states, includes 250 transfer stations and 30 landfills, using 3500 trailers.

IDcard Encoder

The IDcard encoder writes data to, and reads data from, the memory chip of the IDcard. The IDcard encoder connects directly to an open parallel printer port in the central controller and is controlled by the central controller software. Due to variances in the DC output driver voltages from different computer systems, the IDcard encoder is supplied with a DC power supply, ensuring a constant power source and compatibly with any selected computer system. When used in conjunction with the central controller and central controller software, the IDcard encoder encodes/revises IDcards with owner-selected confidential access codes to assure complete security against unauthorized system access and to permit accurate recording of site transactions to the IDcard by the WMU (site controller).

Central Controller Software-Trip Management Software

When loaded in a personal computer, the trip management software provides an operating program for data and reporting control by the WMU(s). The central controller communicates with the WMU to download transaction data, upload authorizations, or to change WMU configuration. The trip management software provided with the system can be designed for modem communications through voice-grade telephone lines.

### System Information

The waste management method and system (trip management system) electronically stores and verifies pertinent data regarding haulers (transporting entities), their drivers, vehicles and trailers, hired to transport waste between various transfer stations and landfill sites.

A driver transporting waste between a transfer station and a landfill is required to stop their vehicle on a weigh scale and present their IDcard to a scale operator (or other owner's representative) upon entering and exiting all transfer stations (first remote site location) and upon entering all landfill sites (second remote site location). At each remote site location, driver, hauler and trailer qualifications are verified.

Transfer Station (TS) Inbound Verification

The transfer station inbound verification: If the hauler's contract, or the driver's insurance, commercial driver's license, or physical examination clearance has expired, or the driver's IDcard has been placed on “lockout” status, the driver, vehicle and load will be denied access to the transfer station.

Transfer Station (TS) Outbound Verification

The transfer station outbound verification: In addition to repeating the transfer station inbound verification, the vehicle is weighed, the trailer number verified (trailer registration and inspection current) and a destination site assigned. Vehicles exceeding regulatory weight limitations, or trailers placed on “lockout” status, will not be permitted to proceed.

Landfill (LF) Inbound Verification

The landfill site inbound verification: In addition to repeating the transfer station inbound verification, the vehicle is weighed, the trailer number verified (same trailer as that leaving transfer station) and the assigned destination site compared with the actual landfill site. Vehicles gaining over a pre-determined weight differential (e.g., 2500 lbs. is an appropriate differential allowing for water weight gain from rain during transport) will not be permitted to proceed. Vehicles arriving at an incorrect destination (landfill), drivers who have switched trailers or drivers delivering trailers placed on “lockout” status, will not be permitted to proceed (deliver).

Transfer Station (TS) Inbound Transaction Data

Site transaction data is created and recorded at each remote site location. The transfer station inbound transaction data recorded into the WMU consists of:

1. Driver SSN (social security number) [9-digit numeric]

2. Date/time [______]

3. Trailer ID [8-digit numeric]

4. Transfer station [6-digit numeric]

5. Transaction type [2-digit numeric]

6. Trip ID

Transfer Station (TS) Outbound Transaction Data

The transfer station outbound transaction data recorded into the WMU consists of:

1. Driver SSN [9-digit numeric]

2. Date/time [______]

3. Gross Vehicle Weight [6-digit numeric]

4. Tare Weight

5. Net Weight

6. Trailer ID [8-digit numeric]

7. Transfer station [6-digit numeric]

8. Destination (landfill) ID [6-digit numeric]

9. Transaction type [2-digit numeric]

10. Trip ID

In addition to recording the transfer station outbound transaction data into the WMU for downloading to the central controller, the transfer station outbound transaction data is written to the driver's IDcard (driver card) for presentation by the driver during the landfill site inbound verification process.

Landfill (LF) Inbound Transaction Data

The landfill inbound transaction data recorded into the WMU consists of:

1. Driver SSN [9-digit numeric]

2. Date/time [______]

3. Gross Vehicle Weight [6-digit numeric]

4. Trailer ID [8-digit numeric]

5. Transfer station [6-digit numeric]

6. Destination (landfill) ID [6-digit numeric]

7. Transaction type [2-digit numeric]

8. Trip ID

Central Controller Database Information

Database information necessary for system operation includes a driver database, hauler database, trailer database, site database and site manager database. The database information is recorded at the central controller and uploaded to respective WMUs at remote site locations (transfer stations and landfills).

Driver Database

The driver database includes the following information:

1. Driver name (Last, First, MI) [40-digit, alphanumeric]

2. Driver ID [11-digit alphanumeric]

3. Driver Social Security Number [9-digit numeric]

4. Hauler ID [5-digit numeric]

5. Driver's License (CDL) number [40-digit, alphanumeric]

6. Driver's License (CDL) expiration date [______]

7. Motor Vehicle Report Expiration Date [______]

8. Physical Expiration date [______]

9. Issue Date of IDcard [______]

10. IDcard Activation Date [______]

11. Photo ID Image file name

12. Authorized Flag

13. Status: active or inactive [1-digit numeric]

Hauler Database

The hauler database includes the following information:

1. Hauler ID [5-digit numeric] (2-digit state code, 3-digit company code)

2. Name of organization [40-digit, alphanumeric]

3. Street Address [40-digit, alphanumeric]

4. City [40-digit, alphanumeric]

5. State [2-digit, alphanumeric]

6. Zip [20-digit, numeric]

7. Telephone Number (primary) [14-digit, alphanumeric]

8. Telephone Number (secondary)[14-digit, alphanumeric]

9. Telephone Number (Fax)[14-digit, alphanumeric]

10. Hauler Contact Person [60-digit, alphanumeric]

11. Email address [40-digit, alphanumeric]

12. Contract Start Date [______]

13. Contract End Date [______]

14. Status: active or inactive [1-digit numeric]

15. DOT (Dept. of Transportation) rating: Satisfactory, Unsatisfactory or Conditional [1-digit numeric]

16. DOT ID [14-digit, alphanumeric]

17. Insurance Company name [60-digit, alphanumeric]

18. Insurance Policy Number [60-digit, alphanumeric]

19. Insurance Company phone number [14-digit, alphanumeric]

20. Insurance Expiration Date [______]

Trailer Database

The trailer database includes the below information for each trailer. A table (listing) of trailers provides each WMU with a look-up table to verify that a trailer ID, entered by keypad entry at the remote site, is valid. Although all of the following data could be uploaded to the WMUs, only the trailer ID and trailer tag expiration date information is routinely uploaded to the WMUs.

1. Trailer ID [11-digit numeric] {2-digit State code, 3-digit company code, & 6-digit trailer number}

2. Hauler ID [5-digit numeric]

3. Miscellaneous field [15-digit alphanumeric]

4. Trailer tag expiration date [______]

5. In-Service/Out-of-Service Flag

6. Authorized Flag

Site Database

The site database includes the below information for each site (transfer stations and landfills). A table (listing) of all sites provides each WMU with a look-up table to verify that a site ID, entered by keypad, is valid. Although all of the following data could be uploaded to the WMUs, only the site ID and site type information is routinely uploaded to the WMUs.

1. Site ID [8-digit numeric] {4-digit district ID, 2-digit site location number & 2-digit WMU number}

2. Site type [1-digit numeric]

3. Site Contact [40-digit alphanumeric]

4. Site Telephone number (primary)[14-digit, alphanumeric]

5. Site Telephone number (secondary)[14-digit, alphanumeric]

6. WMU Telephone number [14-digit, alphanumeric]

7. Fax number [14-digit, alphanumeric]

8. Responsible Organization (Company identifier) [40-digit alphanumeric]

Site Manager Database

The site manager database includes the below information for each site manager. A table (listing) of site managers provides each WMU with a look-up table to verify that a site manager ID, entered by keypad entry at a remote site, is valid. Although all of the following data could be uploaded to the WMUs, only the site manager IDs are routinely uploaded to the WMUs.

1. Site Manager ID (SSN) [9-digit numeric]

2. Manager Name (Last, First, MI) [40-digit, alphanumeric]

3. Street Address [40-digit, alphanumeric]

4. City [40-digit, alphanumeric]

5. State [2-digit, alphanumeric]

6. Zip [20-digit, numeric]

7. Telephone Number (primary) [14-digit, alphanumeric]

8. Telephone Number (secondary)[14-digit, alphanumeric]

9. Telephone Number (Fax)[14-digit, alphanumeric]

10. Email address [40-digit, alphanumeric]

11. Authorized Flag

Central Controller Driver Card Encoding

The driver card (IDcard) includes a read/write memory chip capable of retaining at least the following data:

1. Driver social security number [9-digit numeric]

2. Commercial driver's license (CDL) number [40-digit, alphanumeric]

3. Motor vehicle report (MVR) expiration date [______]

4. Commercial driver's license (CDL) expiration date [______]

5. Physical expiration date [______]

6. Earliest expiration date between Physical, MVR or CDL [______]

7. Hauler ID [5-digit numeric]

8. IDcard activation date [______]

9. Space for WMU to write destination landfill ID [6-digit numeric]

10. Space for WMU to write gross total weight (GTW) [6-digit numeric]

11. Space for WMU to write trailer ID [8-digit numeric]

12. Space for WMU to write transfer station ID [6-digit numeric]

13. Space for WMU to write transfer station time stamp [10-digit numeric]

Items 1-8, above, are encoded by the central controller. Only the central encoder is capable of revising this data. Items 9-13 are written to the (at transfer station) and cleared from the card (at landfill) by a respective WMU.

Central Controller Site Manager Card Encoding

The site manager card includes a read/write memory chip capable of retaining at least the following data, providing site managers with authority to perform the following:

1. Trailer ID override (TS outbound & LF Inbound)

2. Manual entry of weights (TS outbound & LF Inbound)

3. Destination landfill override [6-digit numeric] (LF Inbound)

4. Differential (2500 lbs) weight increase override (LF Inbound)

5. Diagnostics of WMU components

6. System (change message duration and timeouts, etc.)

Trip Management Software

The trip management software of the central controller enables management personnel at the central management location to monitor the following criteria, and upload the following to each WMU for authorization use during the site verification (site access approval) process:

Hauler has signed contract in place

Hauler has certificate of insurance in place

Driver has valid driver's license

Driver has an acceptable DOT record

Driver has an acceptable Medical record

Trailer has valid inspection and license

The trip management software is capable of deleting criteria from, or adding criteria to, the databases listed above, for monitoring or verification purposes.

Reports

The trip management software is capable of providing flexible, user defined reporting of credential expirations for the haulers, drivers and trailers. The software can generate hard copy notification of upcoming expirations, or upcoming expirations can be uploaded to WMUs for notification during the next site by the subject hauler, driver or trailer. For example, during a transfer site inbound verification, a WMU will notify a driver that one of his credentials (or a credential of his employer (hauler)) is due to expire within a specific period of time. Of course, if a credential of the driver (or respective hauler) has expired, the driver will be notified, and perhaps denied site access.

The trip management software periodically downloads transaction data from the WMUs (usually twice a day) and is capable of generating a variety of reports. Examples are:

1. An Exception Report including lists of one or more of the following:

a. All uncompleted trips since the last transaction download (i.e., each transfer station outbound transaction without a inbound landfill transaction for the same driver);

b. Site authorizations by a site manager (not assigned on driver card);

c. All uncompleted trips from earlier transaction downloads;

d. Trips with trailer weight gains exceeding pre-determined limits (excessive differentials), and whether site manager override occurred.

2. A Transaction Report (of hauler and/or driver), grouping three transactions:

a. Transfer Station—Inbound

b. Transfer Station—Outbound

c. Landfill Site—Inbound

Transfer Station—Outbound and Landfill—Inbound are compared, showing start and finish (date/time) for an assigned waste haul route.

3. A Hauler Activity Report (each set of transactions by hauler, with weight), showing total weight by organization, and total weight by organization to a particular landfill, for a given period. These reports can be used by accounts payable departments.

4. A Trip Report (listing completed trips and grouping by particular trips) including: hauler, transfer station, landfill and weights.

5. Period Reports—Within any user definable period, data groupings by site, driver, trailer and hauler.

6. System Database reports—for any database included in the system (driver report, hauler report, etc.), providing current lists of all drivers, haulers, trailers, site managers, etc.

### Method of Operation

Transfer Station (TS) Inbound Procedure

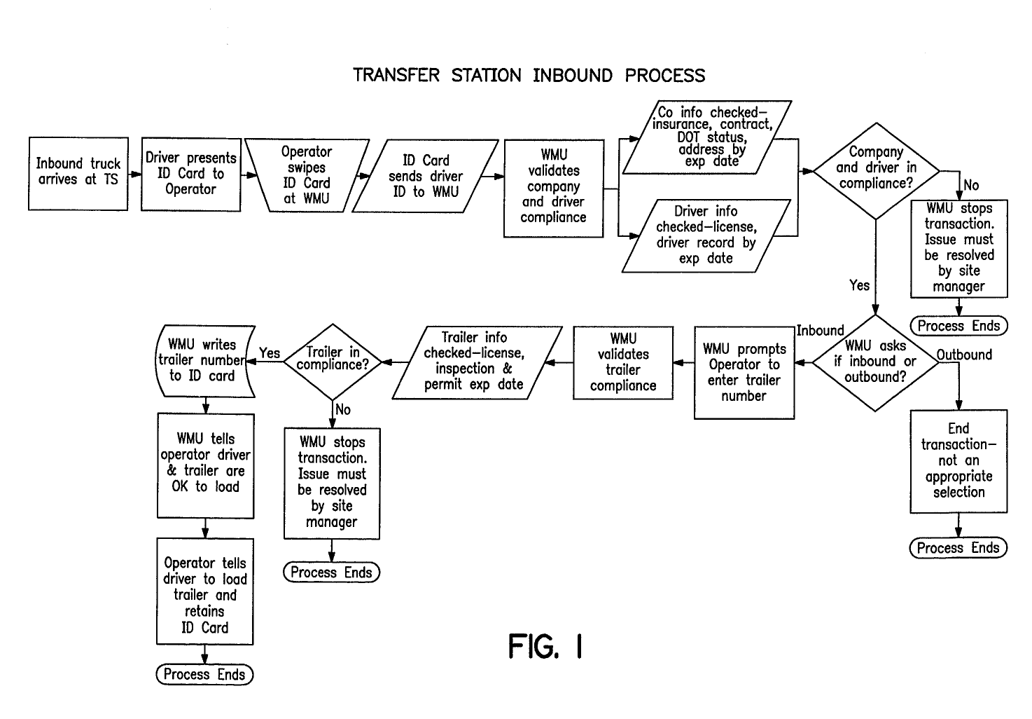

The transfer station inbound verification and transaction process undertaken by a respective driver is detailed by flow diagram in FIG. 1, and summarized below:

Driver arrives at Transfer Station: Once directed, proceeds onto the scales. The driver presents the scale operator or site manager with his/her IDcard.

After verifying the driver's picture, the scale operator inserts the IDcard into the WMU (site controller).

The WMU reads the IDcard and determines whether the driver and hauler are in compliance with the pre-determined characteristics required by the Transportation Management entity.

If “compliant”, the WMU prompts the scale operator to enter whether the vehicle is “inbound” or “outbound”.

Upon entering “inbound”, the WMU prompts the scale operator to enter the trailer ID. The WMU validates trailer compliance. If compliant, the scale operator writes the trailer ID to the IDcard, retains the driver's IDcard, and informs the driver to proceed to the loading area.

Once the trailer is loaded, the driver returns with the load to the transfer station outbound scale.

Transfer Station (TS) Outbound Procedure

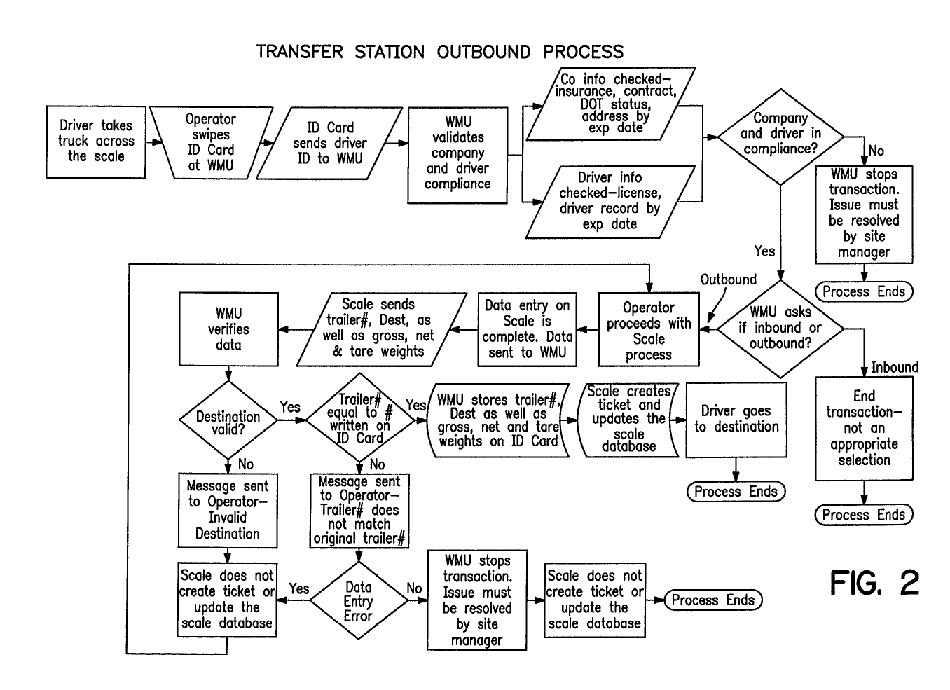

The transfer station outbound verification and transaction process undertaken by a respective driver is detailed by flow diagram in FIG. 2, and summarized below:

Once the trailer is loaded, the driver returns with the load to the transfer station outbound scale to weigh out.

The driver's IDcard is again entered into the WMU.

If hauler/driver is found compliant, the WMU prompts the scale operator to enter whether the driver is “inbound” or “outbound”.

Upon entering “outbound”, the “inbound” transaction ends and the scale operator proceeds with the weighing process and entry of data to scale equipment and software (or directly to the WMU if the scale equipment is not computerized).

If data is entered to scale software, the scale software transmits the data to the WMU. Data includes trailer ID, destination ID, gross, net and tare weights.

WMU verifies IDcard data, weight, destination ID and trailer ID.

WMU writes weight, destination ID and trailer ID to driver's IDcard.

Scale software creates a weigh ticket and the IDcard is returned to driver. The driver proceeds to the assigned destination.

If, at any time during the verification and transaction process, the transaction is terminated, the scale operator directs the driver to a staging area to await further instructions and site manager action.

Landfill Inbound Procedure

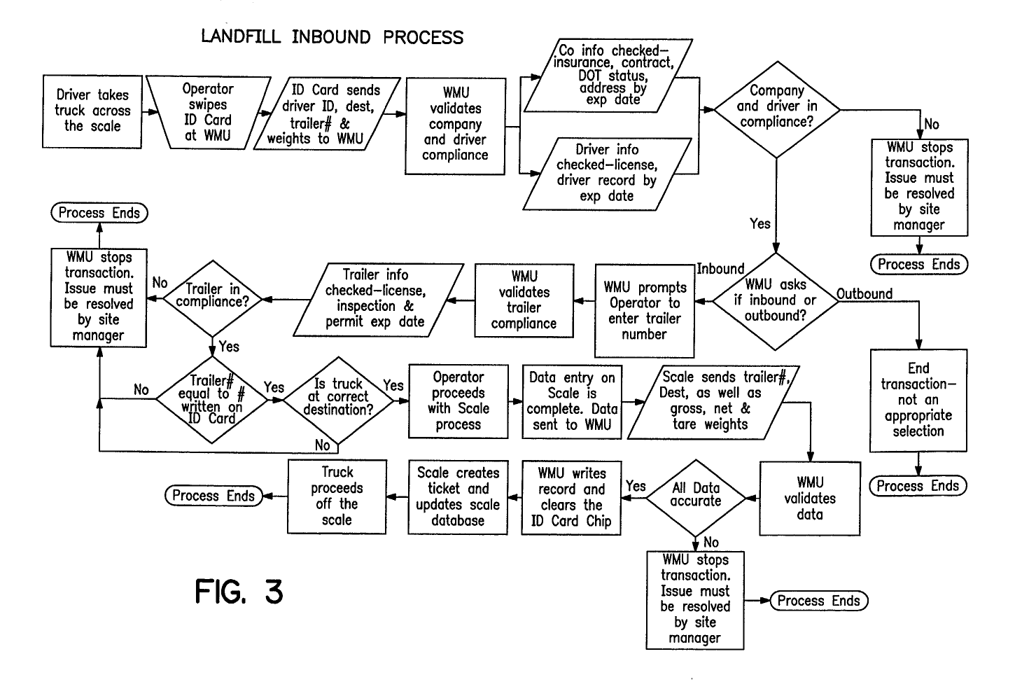

The landfill inbound verification and transaction process undertaken by a respective driver is detailed by flow diagram in FIG. 3, and summarized below:

Driver arrives at Landfill: Once directed, proceeds onto the scales. The driver presents the scale operator his/her IDcard, the load manifest and weigh tickets.

After verifying the driver's picture, the scale operator inserts the IDcard into the WMU (site controller).

The WMU reads the IDcard and determines whether the driver and hauler are in compliance with the pre-determined characteristics required by the Transportation Management entity.

If compliant, the WMU prompts the scale operator to enter whether the vehicle is “inbound” or “outbound”. Upon entering “inbound”, the WMU prompts the scale operator to enter the ID of the trailer delivered. The WMU validates trailer compliance.

If the trailer is compliant, the WMU verifies the trailer ID entered to the WMU is the same as the trailer ID written to the IDcard at the transfer station. The WMU also verifies whether the driver has arrived at the destination (landfill) assigned, as written to the IDcard at the transfer station.

If all is in order, the vehicle is weighed and data is entered to the scale equipment and software (or directly to the WMU if the scale equipment is not computerized). If data is entered to the scale software, the scale software transmits the data to the WMU. Data includes gross, net and tare weights. If the vehicle weighs more than a pre-determined limit (defined as the vehicle weight leaving the transfer station plus a differential, the differential possibly equaling 2500 pounds), the process is terminated and the site manager consulted. Until resolution by the site manager, the scale operator retains the driver's IDcard, all paper work, and directs the driver and vehicle to a designated staging area. This process also occurs for any instance of non-compliance during the landfill verification and transaction process. The site manager has authority, through use of his site manager card communicating with the WMU, to override non-compliant credentials and authorize driver access to the landfill.

Upon compliance with all credentials, and/or resolution of all issues by the site manager, the WMU records the transaction data and clears the IDcard of updateable data (transfer site transaction data). The scale operator instructs the driver to unload.

The waste management method and system of the present invention is instrumental in preventing problems directed to overweight loads, unqualified drivers and improper routing of deliveries. Trailers are recorded as leaving a transfer station within state regulated highway load limits. Drivers are prevented from delivering loads (both type and quantity) to a landfill other than the load assigned at the transfer station. Drivers are prevented from traversing routes other than the most direct, efficient route between transfer station and assigned landfill. Unqualified haulers, drivers and trailers are prevented from operating on the roadways.

The problems prevented by the present invention increase the overall operational efficiency of the transportation network, resulting in cost reductions to the transportation management entity. More deliveries per time period per hauler have resulted. Efficiencies have improved for the subcontract haulers as well, all of the above verifiable by periodic reports generated by the present invention and evaluated for improvements over time.

These and other advantages of the present invention will be apparent to those skilled in the art from the foregoing specification. Accordingly, it will be recognized by those skilled in the art that changes or modifications may be made to the above-described embodiments without departing from the broad inventive concepts of the invention. It should therefore be understood that this invention is not limited to the particular embodiments described herein, but is intended to include all changes and modifications that are within the scope and spirit of the invention.

What is claimed is:

1. A transportation management system comprising:
a. a site controller located at each of at least two remote sites, the site controller authorizing site access and recording site transaction data;
b. a central controller in communication with the site controllers, the central controller receiving site transaction data from the site controllers and transmitting operating information and site access authorization data to the site controllers; and
c. at least one identification device that interacts with the site controllers, the identification device identifying a transporting entity desiring access to a respective site, the respective site controller authorizing site access to the transporting entity upon verification of pre-determined credentials and recording site transaction data.

2. The transportation management system of claim 1, wherein the site transaction data involves the transportation of waste.

3. The transportation management system of claim 2, wherein the remote site is a transfer station or a landfill.

4. The transportation management system of claim 3, wherein the site controller communicates with at least one weigh scale at the transfer station or the landfill.

5. The transportation management system of claim 4, wherein the site transaction data recorded includes vehicle weight.

6. The transportation management system of claim 1, wherein the site transaction data includes site inbound data and site outbound data.

7. The transportation management system of claim 6, wherein the site inbound data includes driver data and trailer identification.

8. The transportation management system of claim 7, wherein the driver data includes driver's license data, physical examination data and insurance data.

9. The transportation management system of claim 6, wherein the site inbound data includes driver data, date and time, gross vehicle weight, trailer identification, site identification, destination identification, transaction type and trip identification.

10. The transportation management system of claim 6, wherein the site outbound data includes driver data, date and time, gross vehicle weight, tare weight, net weight, site identification, destination identification, transaction type and trip identification.

11. The transportation management system of claim 1, wherein the identification device is a card having a read/write memory chip.

12. The transportation management system of claim 11, wherein the central controller includes an encoder that writes data to, and reads data from, the memory chip.

13. The transportation management system of claim 11, wherein the card is encoded as a driver card or a site manager card.

14. The transportation management system of claim 13, wherein the driver card includes driver employment information, state driver's license information and medical information.

15. The transportation management system of claim 13, wherein the site manager card permits a site manager to override pre-determined requirements for site access.

16. The transportation management system of claim 13, wherein the site manager card permits a site manager to override pre-determined transaction limitations.

17. The transportation management system of claim 13, wherein the site manager card permits a site manager to manually record site transaction data.

18. The transportation management system of claim 1, wherein the transporting entity is a sub-contract hauler represented by a driver operating a vehicle having a trailer.

19. The transportation management system of claim 18, wherein the operating information transmitted by the central controller to the site controller includes hauler data, driver data and trailer data.

20. The transportation management system of claim 19, wherein the hauler data includes organization contact information, contract information and insurance information.

21. The transportation management system of claim 19, wherein the driver data includes employment information, state driver's license information and medical information.

22. The transportation management system of claim 19, wherein the trailer data includes identification information, owner information, state registration and inspection information.

23. The transportation management system of claim 1, wherein the operating information transmitted from the central controller to the site controllers includes upcoming transporting entity credential expirations for notification to a subject transporting entity by a respective site controller during a next, subsequent site access authorization.

24. The transportation management system of claim 1, wherein the central controller generates an exception report.

25. The transportation management system of claim 1, wherein the central controller generates a transaction report.

26. A waste management system comprising:
a. a site controller located at each of at least one transfer station and at least one landfill, the site controller authorizing site access to the transfer station and the landfill;
b. a central controller in communication with the site controllers, the central controller transmitting operating information and site access authorization data to the site controllers; and
c. an identification device used by each transporting entity desiring access to the transfer site and landfill, the identification device containing transporting entity characteristics and interacting with the site controllers, the site controllers authorizing site access to the transporting entity upon verification of pre-determined transporting entity characteristics using operating information and site access authorization data transmitted from the central controller.

27. A waste management system comprising:
a. a site controller located at each of at least one transfer station and at least one landfill, the site controller authorizing site access and recording site transaction data at the transfer station and the landfill;
b. a central controller in communication with the site controllers, the central controller receiving site transaction data from the site controllers and transmitting operating information and site access authorization data to the site controllers; and
c. an identification device used by each transporting entity desiring access to the transfer station and landfill, the identification device containing transporting entity characteristics and interacting with the site controllers, the site controllers authorizing site access to the transporting entity upon verification of pre-determined transporting entity characteristics using operating information and site access authorization data transmitted from the central controller, the site controllers writing the site transaction data to the identification device.

28. A waste management system comprising:
a. a site controller located at each multiple transfer stations and landfills, the site controller electronically authorizing site access and recording site transaction data at the transfer stations and the landfills;
b. a central controller in communication with the site controllers, the central controller electronically receiving site transaction data from the site controllers and transmitting operating information and site access authorization data to the site controllers; and
c. an identification card having a memory chip, the identification card used by each transporting entity desiring access to a respective transfer station or landfill, the memory chip retaining transporting entity characteristics and electronically interacting with the site controllers, the site controllers electronically authorizing site access to the transporting entity upon verification of pre-determined transporting entity characteristics using operating information and site access authorization data transmitted from the central controller, the site controllers writing the site transaction data to the memory chip.

29. A method for controlling access to sites of a transportation network, comprising the steps of:
a. verifying pre-determined characteristics of a transporting entity at a first remote site, a positive verification providing the transporting entity access to the first remote site;
b. recording pre-determined first remote site transaction data; and
c. verifying pre-determined characteristics of the transporting entity and certain pre-determined first remote site transaction data at a second remote site, a positive verification providing the transporting entity access to the second remote site.

30. A method for managing and monitoring a transportation network, comprising the steps of:
a. verifying pre-determined characteristics of a transporting entity at a first remote site, a positive verification providing the transporting entity access to the first remote site;
b. recording pre-determined first remote site transaction data;
c. verifying pre-determined characteristics of the transporting entity at a second remote site, a positive verification providing the transporting entity access to the second remote site;
d. recording pre-determined second remote site transaction data; and
e. evaluating the first remote site transaction data with the second remote site transaction data creating statistics used to manage and monitor the transportation network.

31. The method of claim 30, wherein the transportation network is a waste hauling network.

32. The method of claim 31, wherein the first remote site is a transfer station and the second remote site is a landfill.

33. The method of claim 32, wherein multiple transfer stations and multiple landfills exist in the waste hauling network.

34. The method of claim 30, wherein the pre-determined characteristics of the transporting entity at the first remote site, the pre-determined characteristics of the transporting entity at the second remote site, the first remote site transaction data and the second remote site transaction data are transmitted to a central controller at a central managing location, whereby the managing and monitoring of the transportation network occurs by using the central controller at the central managing location.

35. The method of claim 30, wherein certain pre-determined characteristics of the transporting entity are verified through communication between an identification device carried by the transporting entity, the identification device possessing the certain pre-determined characteristics of the transporting entity and a site controller located at the respective first or second remote site.

36. The method of claim 35, wherein the site controller evaluates the certain pre-determined characteristics of the transporting entity and determines whether the transporting entity can access the respective first or second remote site.

37. The method of claim 36, wherein a central controller maintains a database of current and pertinent transporting entity characteristics and maintains criteria for use by the site controller to evaluate the certain pre-determined characteristics of the transporting entity and determine whether the transporting entity can access the respective first or second remote site, the central controller periodically communicating the database to the site controller.

38. The method of claim 35, wherein the identification device is a card including a read/write memory chip.

39. The method of claim 38, wherein the card is encoded with transporting entity data by a central controller located at a central managing location.

40. The method of claim 38, wherein the card is encoded with the first remote site transaction data by the site controller at the first remote site.

41. The method of claim 40, wherein the pre-determined characteristics of the transporting entity at a second remote site includes transporting entity data encoded to the card by a central controller located at a central managing location and the first remote site transaction data encoded to the card by the site controller at the first remote site.

42. The method of claim 41, wherein positive verification providing the transporting entity access to the second remote site requires that the transporting entity data and the first remote site transaction data comply with certain pre-determined requirements.

43. The method of claim 30, wherein the first and the second remote site transaction data includes vehicle weight.

44. The method of claim 30, wherein the first site transaction data includes first site inbound data and first site outbound data.

45. The method of claim 44, wherein the first site inbound data includes driver data, date and time, gross vehicle weight, trailer identification, first remote site identification, transaction type and trip identification.

46. The method of claim 44, wherein the first site outbound data includes driver data, date and time, gross vehicle weight, tare weight, net weight, first remote site identification, destination identification, transaction type and trip identification.

47. The method of claim 30, wherein the second site transaction data includes second site inbound data.

48. The method of claim 47, wherein the second site inbound data includes driver data, date and time, gross vehicle weight, trailer identification, first remote site identification, destination identification, transaction type and trip identification.

49. The method of claim 30, wherein the transportation entity is a third-party hauler represented by a driver operating a vehicle having a trailer.

50. The method of claim 49, wherein certain pre-determined characteristics of the hauler at the first remote site and the second remote site includes hauler data, driver data and trailer data.

51. The method of claim 50, wherein the hauler data includes transportation entity contact information, contract information, and insurance information.

52. The method of claim 51, wherein positive verification providing the hauler access to the first remote site and the second remote site requires that the hauler data comply with certain pre-determined requirements.

53. The method of claim 50, wherein the driver data includes employment information, state driver's license information, and medical information.

54. The method of claim 53, wherein positive verification providing the driver access to the first remote site and the second remote site requires that the driver data comply with certain pre-determined requirements.

55. The method of claim 50, wherein the trailer data includes identification information, owner information, state registration and inspection information.

56. The method of claim 55, wherein positive verification providing the hauler access to the first remote site and the second remote site requires that the trailer data comply with certain pre-determined requirements.

57. The method of claim 30, wherein one pre-determined characteristic of the transporting entity at the second remote site is a vehicle weight not exceeding a pre-determined limit, the pre-determined limit equaling a vehicle weight recorded as part of the first remote site transaction data plus a differential, whereby a transporting entity at the second remote site having a vehicle weight exceeding the pre-determined limit is denied access to the second remote site.

58. The method of claim 57, wherein the differential is 2500 pounds.

59. The method of claim 30, wherein one pre-determined characteristic of the transporting entity at the second remote site is a destination identification assigned as part of the first remote site transaction data matching the destination identification of the respective second remote site, whereby a transporting entity at the second remote site having a destination identification assigned as part of the first remote site transaction data differing from the destination identification of the respective second remote site is denied access to the second remote site.

60. The method of claim 30, wherein one pre-determined characteristic of the transporting entity at the second remote site is a trailer identification recorded as part of the first remote site transaction data matching the trailer identification of the trailer delivered to the second remote site, whereby a transporting entity at the second remote site having a trailer identification recorded as part of the first remote site transaction data differing from the trailer identification of the trailer delivered to the second remote site is denied access to the second remote site.

61. The method of claim 30, wherein the statistics created to manage and monitor the transportation network include an exception report listing all uncompleted trips, and uncompleted trip defined as first remote site transaction data recorded without a subsequent second remote site transaction data.

62. The method of claim 30, wherein the statistics created to manage and monitor the transportation network include an exception report listing trips with trailer weight gains exceeding pre-determined limits.

63. The method of claim 30, wherein the statistics created to manage and monitor the transportation network include an exception report listing site authorizations by a site manager.

64. The method of claim 30, wherein the statistics created to manage and monitor the transportation network include a transaction report listing second remote site transaction data and first remote site transaction data comparing date and time of start and finish for an assigned haul route.

65. The method of claim 30, wherein the statistics created to manage and monitor the transportation network includes upcoming transporting entity credential expirations for notification to a subject transporting entity during a next, subsequent first or second remote site verification.

66. A method for managing and monitoring a transportation network, comprising the steps of:
a. verifying pre-determined characteristics of a transporting entity at a first remote site, a positive verification providing the transporting entity access to the first remote site;
b. recording pre-determined first remote site transaction data;
c. verifying pre-determined characteristics of the transporting entity and certain pre-determined first remote site transaction data at a second remote site, a positive verification providing the transporting entity access to the second remote site;
d. recording pre-determined second remote site transaction data; and
e. evaluating the first remote site transaction data with the second remote site transaction data creating statistics used to manage and monitor the transportation network.

67. A method for managing waste transporting, comprising the steps of:
a. verifying pre-determined characteristics of a transporting entity at a transfer station, a positive verification providing the transporting entity access to pick-up at the transfer station;
b. recording pre-determined transfer station transaction data;
c. verifying pre-determined characteristics of the transporting entity and certain pre-determined transfer station transaction data at a landfill, a positive verification providing the transporting entity access to deliver at the landfill;
d. recording pre-determined landfill transaction data; and
e. evaluating the transfer station transaction data with the landfill transaction data creating statistics used to manage and monitor waste transporting.

68. A method for managing waste transporting, comprising the steps of:
a. verifying pre-determined characteristics of a hauler, driver and trailer at a transfer station, a positive verification providing the driver access to waste pick-up at the transfer station;
b. recording pre-determined transfer station transaction data, including weight, destination identification, and date and time of waste pick-up;
verifying pre-determined characteristics of the hauler, driver, trailer, and certain pre-determined transfer station transaction data, including weight, destination identification, and date and time of waste pick-up, at a landfill, a positive verification providing the driver access to deliver waste to the landfill;
d. recording pre-determined landfill transaction data, including date and time of delivery, and weight gain during delivery; and
e. evaluating the transfer station transaction data with the landfill transaction data creating statistics used to manage and monitor waste transporting.

69. A method for managing waste transporting, comprising the steps of:
a. verifying pre-determined characteristics of a hauler, driver and trailer at a transfer station, a positive verification providing the driver access to waste pick-up at the transfer station;
b. recording pre-determined transfer station transaction data, including weight, destination identification, and date and time of waste pick-up;
c. verifying pre-determined characteristics of the hauler, driver, trailer, and certain pre-determined transfer station transaction data, including weight, destination identification, and date and time of waste pick-up, at a landfill, a positive verification providing the driver access to deliver waste to the landfill;
d. recording pre-determined landfill transaction data, including date and time of delivery, and weight gain during delivery; and
e. evaluating the transfer station transaction data with the landfill transaction data creating statistics, including exception reports, used to manage and monitor waste transporting.

70. A computer-readable medium that configures a computer system to perform a method, the method comprising the steps of:
a. verifying pre-determined characteristics of a transporting entity at a first remote site, a positive verification providing the transporting entity access to the first remote site;
b. recording pre-determined first remote site transaction data; and
c. verifying pre-determined characteristics of the transporting entity and certain pre-determined first remote site transaction data at a second remote site, a positive verification providing the transporting entity access to the second remote site.

71. A computer-readable medium that configures a computer system to perform a method, the method comprising the steps of:
a. verifying pre-determined characteristics of a transporting entity at a first remote site, a positive verification providing the transporting entity access to the first remote site;
b. recording pre-determined first remote site transaction data;
c. verifying pre-determined characteristics of the transporting entity at a second remote site, a positive verification providing the transporting entity access to the second remote site;
d. recording pre-determined second remote site transaction data; and
e. evaluating the first remote site transaction data with the second remote site transaction data creating statistics used to manage and monitor the transportation network.

72. A computer-readable medium that configures a computer system to perform a method, the method comprising the steps of:
a. verifying pre-determined characteristics of a transporting entity at a first remote site, a positive verification providing the transporting entity access to the first remote site;
b. recording pre-determined first remote site transaction data;
c. verifying pre-determined characteristics of the transporting entity and certain pre-determined first remote site transaction data at a second remote site, a positive verification providing the transporting entity access to the second remote site;
d. recording pre-determined second remote site transaction data; and
e. evaluating the first remote site transaction data with the second remote site transaction data creating statistics used to manage and monitor the transportation network.

73. A computer-readable medium that configures a computer system to perform a method, the method comprising the steps of:
a. verifying pre-determined characteristics of a transporting entity at a transfer station, a positive verification providing the transporting entity access to pick-up at the transfer station;
b. recording pre-determined transfer station transaction data;
c. verifying pre-determined characteristics of the transporting entity and certain pre-determined transfer station transaction data at a landfill, a positive verification providing the transporting entity access to deliver at the landfill;
d. recording pre-determined landfill transaction data; and
e. evaluating the transfer station transaction data with the landfill transaction data creating statistics used to manage and monitor waste transporting.

74. A computer-readable medium that configures a computer system to perform a method, the method comprising the steps of:
a. verifying pre-determined characteristics of a hauler, driver and trailer at a transfer station, a positive verification providing the driver access to waste pick-up at the transfer station;
b. recording pre-determined transfer station transaction data, including weight, destination identification, and date and time of waste pick-up;
c. verifying pre-determined characteristics of the hauler, driver, trailer, and certain pre-determined transfer station transaction data, including weight, destination identification, and date and time of waste pick-up, at a landfill, a positive verification providing the driver access to deliver waste to the landfill;
d. recording pre-determined landfill transaction data, including date and time of delivery, and weight gain during delivery; and
e. evaluating the transfer station transaction data with the landfill transaction data creating statistics used to manage and monitor waste transporting.

75. A computer-readable medium that configures a computer system to perform a method, the method comprising the steps of:
a. verifying pre-determined characteristics of a hauler, driver and trailer at a transfer station, a positive verification providing the driver access to waste pick-up at the transfer station;
b. recording pre-determined transfer station transaction data, including weight, destination identification, and date and time of waste pick-up;
c. verifying pre-determined characteristics of the hauler, driver, trailer, and certain pre-determined transfer station transaction data, including weight, destination identification, and date and time of waste pick-up, at a landfill, a positive verification providing the driver access to deliver waste to the landfill;
d. recording pre-determined landfill transaction data, including date and time of delivery, and weight gain during delivery; and
e. evaluating the transfer station transaction data with the landfill transaction data creating statistics, including exception reports, used to manage and monitor waste transporting.

76. A computer-readable medium that that stores a program, the program comprising:
a. means for verifying pre-determined characteristics of a transporting entity at a first remote site, a positive verification providing the transporting entity access to the first remote site;
b. means for recording pre-determined first remote site transaction data; and
c. means for verifying pre-determined characteristics of the transporting entity and certain pre-determined first remote site transaction data at a second remote site, a positive verification providing the transporting entity access to the second remote site.

77. A computer-readable medium that that stores a program, the program comprising:
a. means for verifying pre-determined characteristics of a transporting entity at a first remote site, a positive verification providing the transporting entity access to the first remote site;
b. means for recording pre-determined first remote site transaction data;
c. means for verifying pre-determined characteristics of the transporting entity at a second remote site, a positive verification providing the transporting entity access to the second remote site;
d. means for recording pre-determined second remote site transaction data; and
e. means for evaluating the first remote site transaction data with the second remote site transaction data creating statistics used to manage and monitor the transportation network.

78. A computer-readable medium that that stores a program, the program comprising:
a. means for verifying pre-determined characteristics of a transporting entity at a first remote site, a positive verification providing the transporting entity access to the first remote site;
b. means for recording pre-determined first remote site transaction data;
c. means for verifying pre-determined characteristics of the transporting entity and certain pre-determined first remote site transaction data at a second remote site, a positive verification providing the transporting entity access to the second remote site;
d. means for recording pre-determined second remote site transaction data; and
e. means for evaluating the first remote site transaction data with the second remote site transaction data creating statistics used to manage and monitor the transportation network.

79. A computer-readable medium that that stores a program, the program comprising:
a. means for verifying pre-determined characteristics of a transporting entity at a transfer station, a positive verification providing the transporting entity access to pick-up at the transfer station;
b. means for recording pre-determined transfer station transaction data;
c. means for verifying pre-determined characteristics of the transporting entity and certain pre-determined transfer station transaction data at a landfill, a positive verification providing the transporting entity access to deliver at the landfill;
d. means for recording pre-determined landfill transaction data; and
e. means for evaluating the transfer station transaction data with the landfill transaction data creating statistics used to manage and monitor waste transporting.

80. A computer-readable medium that that stores a program, the program comprising:
a. means for verifying pre-determined characteristics of a hauler, driver and trailer at a transfer station, a positive verification providing the driver access to waste pick-up at the transfer station;
b. means for recording pre-determined transfer station transaction data, including weight, destination identification, and date and time of waste pick-up;
c. means for verifying pre-determined characteristics of the hauler, driver, trailer, and certain pre-determined transfer station transaction data, including weight, destination identification, and date and time of waste pick-up, at a landfill, a positive verification providing the driver access to deliver waste to the landfill;
d. means for recording pre-determined landfill transaction data, including date and time of delivery, and weight gain during delivery; and
e. means for evaluating the transfer station transaction data with the landfill transaction data creating statistics used to manage and monitor waste transporting.

81. A computer-readable medium that that stores a program, the program comprising:
a. means for verifying pre-determined characteristics of a hauler, driver and trailer at a transfer station, a positive verification providing the driver access to waste pick-up at the transfer station;
b. means for recording pre-determined transfer station transaction data, including weight, destination identification, and date and time of waste pick-up;
c. means for verifying pre-determined characteristics of the hauler, driver, trailer, and certain pre-determined transfer station transaction data, including weight, destination identification, and date and time of waste pick-up, at a landfill, a positive verification providing the driver access to deliver waste to the landfill;
d. means for recording pre-determined landfill transaction data, including date and time of delivery, and weight gain during delivery; and
e. means for evaluating the transfer station transaction data with the landfill transaction data creating statistics, including exception reports, used to manage and monitor waste transporting.
